(19) United States
(12) Patent Application Publication
(10) Pub. No.: US 2019/0270231 A1
(43) Pub. Date: Sep. 5, 2019

(54) PLASTIC STRAP AND PROCESS FOR MANUFACTURING PLASTIC STRAPS

(71) Applicant: TEUFELBERGER Ges.m.b.H., Wels (AT)

(72) Inventors: Thomas GAHLEITNER, Krenglbach (AT); Thomas KRZIWANEK, Wels (AT)

(73) Assignee: TEUFELBERGER Ges.m.b.H., Wels (AT)

(21) Appl. No.: 16/343,131

(22) PCT Filed: Oct. 18, 2017
(86) PCT No.: PCT/AT2017/060268

§ 371 Date: Apr. 18, 2019

(30) Foreign Application Priority Data
Oct. 19, 2016 (DE) 10 2016 119 898.6

(51) Int. Cl. B29C 48/00; B29C 48/10; B29C 48/28; B29C 48/88; B29C 59/02; B29C 59/04

(52) U.S. Cl. CPC B29C 48/002; B29C 48/0018; B29C 48/0022; B29C 48/10; B29C 48/28; B29K 2101/12; B29C 48/919; B29C 59/022; B29C 59/04; B29C 2059/023; B29C 48/9135

(57) ABSTRACT

A plastic strap includes a semi-crystalline thermoplastic material which is monoaxially or predominantly monoaxially stretched during a process for manufacturing the plastic strap. At least one surface of the plastic strap is provided with a microstructure, in particular a microstructure that cannot be optically resolved by the human eye.

The invention relates to a plastic strap and to a method for the production of plastic straps.

In the packaging industry and for securing and packaging of articles and goods, straps made of plastic have replaced the steel straps that were previously customary for this purpose in many areas. Because of the degree of stretching in the case of such plastic straps, which can be high in cases, tear resistance values and tensile strengths can be achieved, in particular, that are comparable with those of the steel straps that were formerly usual. In the case of very high degrees of stretching and sufficient strip thickness or grammage of plastic straps, these can actually surpass the tear resistance or tensile strength of a steel strap.

In this regard, the monoaxial or at least predominantly monoaxial stretching of these straps made of plastic brings about the great tensile strengths or tear resistance values of the straps. Specifically because of this monoaxial stretching, however, these plastic straps are also susceptible to a great tendency to tear or fray in the longitudinal direction, also known as longitudinal splitting. This is primarily due to the orientation of the macromolecular chains of the respective plastic material, which is oriented predominantly in the longitudinal direction or in the direction of a longitudinal expanse of the straps. Because of this preferential orientation of the macromolecules, relatively little intermolecular cohesion is present in the stretched material transverse to the longitudinal direction of the plastic straps. The great susceptibility to tearing or fraying in the longitudinal direction, in particularly in the case of straps that are stretched to a high degree, must be taken into consideration both in their use for strapping and in the case of any method steps that are carried out after stretching during the production process.

Plastic straps are usually available with macro-profiled or smooth surfaces. In this regard, plastic straps having a smooth surface are predominantly used for packaging or strapping of goods for which particularly high tensile strengths are required, such as for bundling of large articles or strapping or encircling entire pallets, for example. This is true, among other things, due to their high grammage in comparison with embossed strips. Such strapping for bundling or securing the transport or goods is frequently carried out in semi-automatic or fully automatic manner, by means of strapping apparatuses. In this regard, the articles to be strapped are encircled with straps, subsequently tightened by machine, and finally, the two longitudinal ends of a strap are connected with one another. In the case of plastic straps, the respective longitudinal strip ends are preferably welded to one another to secure a tightened strip.

Fundamentally, in this regard, welding of the longitudinal ends can be carried out by means of fillet welding or friction welding. In the case of hot fillet welding, the two longitudinal ends are heated at their surface by means of a heated heating fillet, for example a metal tongue, and subsequently pressed onto one another. In the case of friction welding, one surface of each of the longitudinal ends of a plastic strap are brought into contact by means of a strapping apparatus, and subsequently moved relative to one another in a rapid oscillating sequence. As a result, the surfaces of the longitudinal ends are heated by the resulting friction heat, and they connect with a material bond due to the pressure applied.

To achieve a good material bond between the two longitudinal ends, in particular in the case of friction welding, good graspability or guidability of the longitudinal ends by or through the guide elements of the strapping apparatuses, as well as good mobility of the surfaces of the longitudinal ends relative to one another, are a prerequisite. In the packaging industry, it is of great importance, above all in the case of friction welding procedures carried out by machine, that a respective individual connection procedure for the two longitudinal ends of a strap can be carried out as quickly as possible.

In the case of plastic straps having a smooth surface, these connection or welding procedures are often problematical. This is true, for one thing, because guide means such as guide jaws or clamping wheels of strapping apparatuses or machines often can only insufficiently guide the smooth surfaces of these straps. In addition, smooth surfaces of plastic straps, when laid against one another or pressed against one another, demonstrate comparatively good adhesion to one another, in each instance, and this can make subsequent movement of the surfaces or of the two longitudinal ends relative to one another, for the purpose of friction welding, significantly more difficult. In particular, in the case of straps made of relatively polar plastic materials, such as polyesters or polyamides, a kind of weak gluing or adhesion effect of the corresponding surfaces on one another can actually come about. This can severely delay friction welding procedures for securing tightened straps, among other things. In disadvantageous cases, a welding procedure can actually be completely impossible, and/or a corresponding plastic strap having a smooth surface can be damaged or actually destroyed during the welding procedure.

In the case of existing solutions, this set of problems is circumvented in that agents that counteract the often strong adhesion of the smooth surfaces to one another are applied to the smooth surface(s) of a smooth plastic strap. Such agents can be formed, for example, by paraffins, silicones, or by wax-like substances. Such agents or others can be applied to the respective surface(s) by means of immersion of the straps in emulsion baths, for example, or by spraying the straps with aerosols or atomized solutions or emulsions of the means, for example.

In this regard, however, the additional material costs that occur due to the corresponding agents applied to the surfaces of the straps are disadvantageous. Furthermore, in particular in the case of long storage times of the straps, it can happen that the applied agents migrate out of or are removed from the surface(s) again, at least in part, and thereby the functional effectiveness of a plastic strap with regard to a welding procedure is at least greatly impaired again.

It was the task of the present invention to overcome the disadvantages of this state of the art, and to make available an improved method for the production of a plastic strap, as well as an improved plastic strap.

This task is accomplished by means of a method for the production of plastic straps and a plastic strap in accordance with the claims.

The method comprises making available a semi-crystalline, thermoplastic plastic material, and melting the plastic material made available. In a further method step, the melted plastic material is extruded to form at least one plastic strand, by means of an extrusion apparatus. Furthermore, the method comprises cooling of the extruded plastic strand, in particular by means of a cooling apparatus, and subsequently, monoaxial or predominantly monoaxial stretching of the plastic strand to form a stretched strand, by means of at least one elongation unit. This stretched strand has two surfaces, which are spaced apart from one another by a thickness of the stretched strand.

It is essential that at least one surface of the stretched strand is provided with a microstructure, i.e. a micro-pattern, by means of a surface treatment apparatus, in particular with a microstructure that cannot be clearly optically resolved by the naked human eye.

As a result, plastic straps having a surface that appears to be smooth optically and has a high grammage can be produced, which straps are suitable, in particular, for strapping procedures in which high tensile strengths of the strap are required. It is advantageous, in this regard, that because of the microstructure that is applied or introduced, the plastic straps produced can nevertheless be excellently processed or used to produce strapping, by machine or with partial or full automation. In particular, tensioning and welding procedures to secure the plastic straps on or around the goods to be encircled can be carried out by machine, without significant difficulties. As a result, the time and energy required subsequently for a respective welding or friction welding procedure, in each instance, can also be reduced in advantageous manner.

In the case of plastic straps in which only one strip surface is provided with a microstructure, the strip surface having the microstructure can be welded to the opposite, non-structured or smooth strip surface, in each instance, during welding of the two longitudinal ends to one another. In the case of plastic straps having a microstructure on both sides, strip surfaces having a microstructure can be welded to one another, in each instance. Fundamentally, the plastic straps can be used or processed for circumferential fixation of goods or articles.

Surprisingly, it has been found that the surface treatment for providing the plastic straps with a microstructure or a micro-pattern can be carried out without the plastic straps being damaged as a result, during or after production. In particular, the stretched plastic strand, during the surface treatment, i.e. the plastic straps, after the surface treatment, demonstrate no significantly increased tendency with regard to separation or tearing or fraying in the longitudinal direction or in the direction of the longitudinal expanse. Furthermore, the mechanical properties of the plastic straps, in particular the high tensile strengths achieved as the result of stretching, can be maintained. The microstructure can be applied at least to partial sections or partial regions of the at least one surface of the stretched plastic strand.

In principle, all stretchable or extendable, semi-crystalline plastic materials, or mixtures or blends of these plastic materials, can be made available as a thermoplastic plastic material. A thermoplastic plastic material in the sense of this description is a meltable or weldable polymer organic solvent, which can be produced synthetically or semi-synthetically from monomer organic molecules and/or biopolymers. A semi-crystalline, thermoplastic plastic material can be selected, for example, from the group of polyolefins, polyesters or polyamides, or mixtures of these polymers. Specifically, a plastic material can be produced from the group of polyolefins or polyesters, or mixtures of them. Furthermore, fillers and/or additives can also be mixed into the plastic material made available.

The plastic material made available can be melted, for example, in a plasticization unit of an extrusion apparatus, for example a screw extruder, as is usual for subsequently shaping in the case of thermoplastic plastic materials. Subsequently, the melted plastic material can be extruded by way of a shaping extrusion tool, having one die or multiple dies, for example, to form a plastic strand. A die can be configured in slot shape, in particular, for production of a semi-finished plastic strand, which is processed further to produce a plastic strap. The subsequent cooling step can fundamentally be carried out passively by passing the extruded plastic strand over a specific cooling segment exposed to ambient air. Preferably, the extruded plastic strand is passed through a cooling apparatus, for example a tempered water bath, for active cooling. By means of cooling, a blank form of the extruded plastic strand can be preserved by means of cooling.

The subsequent stretching procedure can be carried out in a known elongation unit, by means of pulling off and expanding the cooled plastic strand. In this regard, the cooled strand is pulled in length monoaxially or predominantly monoaxially, in a main stretching direction along the elongation unit, to produce a stretched strand or a stretched plastic strand. A stretching ratio of the stretched strand along the main stretching direction after stretching can amount to between 2 and 20, for example. Preferably, the stretching ratio of the stretched strand amounts to between 3 and 15, in particular between 4 and 12. After stretching, the stretched strand can be structured in strip shape or film shape.

The surface treatment apparatus can be formed, for example, by a laser treatment apparatus, by means of which the at least one surface of the stretched strand can be provided with the microstructure or micro-pattern. Alternatively, however, it is conceivable to provide the at least one surface of the stretched plastic strand with a microstructure using a surface treatment apparatus in the manner of a sand-blasting device, using solid particles to process the at least one surface of the stretched plastic strand. In this regard, the solid particles used to apply or introduce the microstructure can have a particle size in the single-digit or two-digit micrometer range. Likewise, chemical methods are conceivable, for example partial etching of the surface(s) of the stretched plastic strand. Preferably, the microstructure is applied to or introduced into the at least one surface of the stretched plastic strand, by means of a mechanical surface treatment apparatus, as will still be explained below.

The microstructure applied to at least one strip surface of the plastic strap in this manner can comprise individual structure elements such as elevations and depressions, the expanse or dimension of which lies in the single-digit and/or two-digit micrometer range. In particular, a microstructure on the at least one strip surface of a plastic strap cannot be optically resolved by the naked human eye, for example from a distance of 1 meter. This means that the microstructure cannot be recognized as a structure by the human eye from an observation distance of 1 meter. This does not mean that a change in the surface after the surface treatment, for example in comparison with the surface of the stretched plastic strand before the surface treatment, would not be generally evident to the human eye. As a result of the microstructure, a surface-treated surface can appear, in particular, to be more matte, in other words frosted as compared with a non-surface-treated, smooth surface of the same plastic material.

In a further development of the method, it can be provided that a polyester, in particular polyethylene terephthalate, is made available as the plastic material.

By provision of a polyester, straps having excellent mechanical properties, in particularly having high tensile strengths can be produced. Polyester materials furthermore demonstrate a relatively low tendency to separate or fray in the longitudinal direction or in the direction of the longitudinal expanse of a respective plastic strap. A polyester can be formed, for example, by polybutylene terephthalate (PBT) or polyethylene naphthalate. Preferably, polyethylene terephthalate is made available as the semi-crystalline, thermoplastic plastic material.

Furthermore, it can be provided that an embossing apparatus comprising at least one embossing roll is used as the surface treatment apparatus.

In this way, a surface treatment apparatus can be made available, by means of which the at least one surface of the stretched plastic strand can be provided with a microstructure, in particular in controlled and gentle manner. In this case, the microstructure is applied to the at least one surface of the stretched plastic strand mechanically, by means of direct contact of a partial section, in each instance, of a correspondingly configured embossing surface of the at least one embossing roll. For this purpose, it is advantageous that only a slight press-down pressure of the embossing roll onto the at least one surface of the stretched plastic strand is required. When using this surface treatment method, a respective microstructure is also highly reproducible. Furthermore, an embossing roll can be inserted into the whole production process for plastic straps, in uncomplicated and seamless manner, so that no compromises need to be made with regard to a guide speed or pull-off speed for a respective plastic strand. In the case that the microstructure merely to one surface of the stretched plastic strand, the stretched plastic strand, for example, can be passed through with direct contact, in each instance, between the embossing roller and a further guide roll having a smooth or non-profiled roll surface, which runs in the opposite direction. Alternatively, a guide track or a guide belt having a smooth surface can also be provided opposite the embossing roll.

Furthermore, it can be practical if the at least one surface of the stretched strand is provided with a microstructure by means of at least one embossing roll having a surface profile with a random structure.

As a result, the plastic strips having a random structure in the micrometer range on at least one strip surface can be produced. An embossing surface of a corresponding embossing roll can be provided with such a random structure with relatively little effort. In particular, in this regard, production measures for ordered structuring with recurring or repeating structure units can be eliminated. For example, the random structure can be produced by means of a laser apparatus, in particular a laser ablation apparatus, the laser beam(s) of which are guided over the surface of the corresponding embossing roll in a path pattern that is generated randomly, with restrictions.

If applicable, other physical methods or mechanical methods, for example blasting with particles in the sense of sand-blasting, or grinding, or also chemical methods such as chemical removal of layers close to the surface, are possible for the production of a random microstructure on the embossing surface of an embossing roll.

In principle, it can also be provided that a random microstructure is applied to or introduced into the at least one surface of the stretched plastic strand by means of other surface treatment apparatuses. For example, apparatuses such as one for restrictedly random blasting of the at least one surface with particles of micrometer size, or a laser apparatus, the laser beam(s) of which are guided over the at least one surface in a restrictedly randomly generated track pattern, can be used for this purpose. In the case of such methods, however, in any case an increased potential for damage to the plastic straps during or after production must be taken into consideration.

In general, it can be provided, in the case of one embodiment of the method, that the at least one surface of the stretched strand is provided with a microstructure by means of at least one embossing roll, having a surface profile or an embossing surface having an average roughness Rₐ between 2 μm and 15 μm. The average roughness Rₐ is frequently also referred to as an arithmetical median roughness value. Preferably, an embossing roll is used, the surface profile or embossing surface of which has an average roughness Rₐ between 4 μm and 12 μm.

Furthermore, it can be practical if the at least one surface of the stretched strand is provided with a microstructure by means of at least one embossing roll having a surface profile or an embossing surface having an averaged roughness depth R_{z} between 10 μm and 100 μm. Preferably, an embossing roll is used, the surface profile or embossing surface of which has an averaged roughness depth R_{z} between 20 μm and 80 μm.

Furthermore, it can be provided that the at least one surface of the stretched strand is provided with a microstructure by means of at least one embossing roll having a surface profile or an embossing surface having an average groove width RSₘ between 50 μm and 400 μm. Preferably, an embossing roll is used, the surface profile or embossing surface of which has an average groove width RSₘ between 100 μm and 300 μm.

By means of the indicated ranges for profile parameters for at least sections of the embossing surface of the embossing roll, it is possible to provide stretched strands or plastic strands with a correspondingly structured embossing structure or microstructure. In this regard, the microprofile of the embossing surface, with the indicated ranges of the profile parameters, is transferred, at least to a great extent, to the at least one surface of the stretched strip as a negative structure. Of course, in this regard the resulting roughness and the averaged roughness depth of the at least one strip surface of the plastic strap depend on the respective penetration depth of the embossing surface of the embossing roll into the stretched strip during the embossing procedure. By means of the use of an embossing roll having the indicated ranges for profile parameters for the embossing surface, it is possible to produce plastic straps without great risk of damage, in particular without significant risk of separation or fraying in the direction of their longitudinal expanse. For this purpose, an average groove width in the range indicated, as well as a restriction of the averaged roughness depth Rz to the range indicated can be advantageous. Furthermore, straps can be produced that have excellent mechanical properties, such as the high tensile strengths required. The ranges for profile parameters of the embossing surface of the at least one embossing roll, as indicated, furthermore allow application or introduction of a microstructure onto or into the at least one surface of the stretched plastic strand, which microstructure guarantees very good weldability, in particular by means of friction welding by machine, when using the plastic straps during a strapping procedure.

The profile parameters for profiles as indicated, as well as methods for determination of these profile parameters, are defined in EN ISO 4287. More recent definitions and area-related or area-capturing measurement methods for profiled surfaces are defined in the standards series EN ISO 25178, wherein the measurement values can in turn be transferred or converted to profile parameters or 2D parameters according to EN ISO 4287.

Preferably, the at least one surface of the stretched strand is provided with a microstructure continuously, in other words in its entirety.

In this way, it can be guaranteed, in particular, that at least one strip surface of a plastic strap is provided with a microstructure in the region of the two longitudinal ends, in each instance. Consequently, positive influencing of the effectiveness and quality of a weld of the two longitudinal ends to one another can be improved by means of the microstructure. Also, a continuous microstructure has a positive effect on guidance by machine, and on tensioning of the plastic strips during the strapping procedure.

However, method management in which both surfaces of the stretched strand are provided with the microstructure, in each instance, or a microstructure, in each instance, can also be advantageous.

In this manner, plastic straps can be produced, which can be guided and welded particularly well in automated manner during the course of strapping or a strapping procedure by machine.

In particular, it can be provided, for this purpose, that the stretched strand is passed through between at least two embossing rolls that lie opposite one another and rotate in opposite directions, each having microstructured embossing surfaces, and that both surfaces of the stretched strand are each provided with a microstructure by means of the two embossing rolls.

As a result, both surfaces of the stretched plastic strand can be provided with a microstructure in highly efficient and particularly gentle manner. Damage during production and/or during subsequent storage or use of a plastic strap can thereby also be prevented.

However, it can also be advantageous if the at least one surface of the stretched strand is provided with a microstructure at a temperature of the stretched strand between 60° C. and 120° C.

In the temperature range indicated, semi-crystalline thermoplastic plastic materials can have sufficiently good formability for efficient provision of the at least one surface of the at least one stretched plastic strand, on the one hand. On the other hand, such plastic materials are sufficiently stable in the indicated temperature range, so that no significant loss of the at least predominantly monoaxial orientation of the macromolecule chains during the mechanical surface treatment needs to be accepted. As a result, plastic straps having very good tensile strengths can be produced.

In this connection, it can be provided, for example, that the stretched strand is tempered by means of at least one embossing roll and/or by means of a tempering apparatus that precedes the at least one embossing roll.

In this way, a desired reference temperature of the stretched strand or plastic strand can be undertaken, particularly efficiently, directly ahead of and/or directly during the surface treatment step for providing the at least one surface with the microstructure. In principle, in this regard, the stretched plastic strand can already be cooled or heated, in each instance, as a function of the temperature directly ahead of the surface treatment step. The at least one embossing roll can have channels for passing a tempered liquid medium through, for example, for tempering of the stretched plastic. Alternatively, for example, electric heating of the at least one embossing roll is also possible. In principle, any apparatus suitable for heating or cooling a stretched strand can be used as a preceding tempering apparatus, for example a water bath or an infrared radiator, etc.

However, the task of the invention is also accomplished by a plastic strap having a longitudinal expanse and, normal to it, a width expanse and a strip thickness, which longitudinal expanse and width expanse form two strip surfaces that are spaced apart from one another by the strip thickness. The plastic strap comprises a semi-crystalline thermoplastic plastic material, which plastic material is stretched monoaxially or predominantly monoaxially in the direction of the longitudinal expanse.

It is essential that at least one of the strip surfaces of the plastic strap is provided with a microstructure, in particular with a microstructure that cannot be clearly resolved optically by the human eye, or at least one strip surface has a corresponding microstructure.

As a result, a plastic strap can be made available with a surface that optically appears smooth and has a high grammage or relatively great weight per surface area, which strap is particularly suitable for strapping procedures in which high tensile strengths of the strap are required. This plastic strap is nevertheless excellently suited for processing by machine or in partly or fully automated manner or for use to form strapping, because of the microstructure. In particular, tensioning and welding procedures for securing the plastic strap on or around the goods to be encircled can be carried out by machine, without significant difficulties. As a result, the time and energy expenditure required for a respective welding or friction welding procedure can also be advantageously reduced, in each instance.

In the case of plastic straps in which only one strip surface is provided with a microstructure, the strip surface having the microstructure can be welded to the opposite, non-structured or smooth strip surface, in each instance, when the two longitudinal ends are welded to one another. In the case of plastic strips that are microstructured on both sides, strip surfaces having a microstructure can be welded to one another, in each instance. In this regard, the strap can be used or processed for circumferential fixation of goods or articles, for example. The mechanical properties of the plastic strap, in particular its tensile strength, are not significantly influenced by the microstructure. Also, the plastic strap does not demonstrate any increased risk for separation or fraying in the direction of the longitudinal expanse, for example in comparison with a strap having the same dimensions and made from the same plastic material, but without a microstructure.

The microstructure can comprise individual structure elements such as elevations and depressions, the expanse or dimension of which can lie in the single-digit to two-digit micrometer range. In particular, a microstructure on the at least one strip surface of the plastic strap cannot be optically resolved by the naked human eye, for example from a distance of 1 meter. This means that the microstructure cannot be recognized as a structure by the human eye from an observation distance of 1 meter. This does not mean that the at least one microstructured strip surface of a plastic strap according to the invention could not be differentiated from a surface of a smooth strap without a microstructure. In particular, the at least one strip surface could appear to be more matte, in other words frosted in comparison with a smooth surface of the same plastic material without a microstructure.

In particular, the plastic strap can be produced in accordance with one or more of the methods and/or method variants indicated above. Surprisingly, it has been shown, in this regard, that a surface treatment for providing the straps with a microstructure or a micro-pattern can be carried out without the plastic straps being damaged as a result, during or after production.

With regard to the strip thickness of the plastic strap, it is understood as a matter of course that this strip thickness can vary, at least slightly, in certain sections or certain regions along the plastic strap, in particular due to the micro-embossing. A strip thickness of the plastic strap can amount to between 0.2 mm and 1.6 mm, for example. Preferably, the strip thickness amounts to between 0.25 mm and 1.4 mm, in particular between 0.3 mm and 1.3 mm.

Examples of stretchable semi-crystalline and thermoplastic plastic materials were already indicated in the description of the method for production of plastic straps, and a repeated explanation at this point is not necessary. The plastic strap can also have fillers or additives in addition to the stretched plastic material.

In particular, it can be provided that the plastic material is formed by a polyester, in particular by polyethylene terephthalate.

As a result, the plastic strap can be made available with excellent mechanical properties, in particular with a particularly high tensile strength. Furthermore, a plastic strap made of such plastic material has a relatively low tendency to separate or fray in the direction of the longitudinal expanse.

In a further development, it can be provided that the microstructure is formed by a micro-embossed structure.

As a result, a plastic strap can be made available, which was provided with a microstructure on at least one strip surface, in particularly gentle manner. This in turn has an advantageous effect on the mechanical properties of the plastic strap.

Furthermore, it can be advantageous if the microstructure is formed by a random structure.

In this way, a plastic strap having a random structure in the micrometer range on at least one strip surface can be made available. Such a random microstructure has proven to be particularly suitable for counteracting fraying or separation of the plastic strap in the direction of the longitudinal expanse, i.e. preventing such separation.

In an embodiment of the plastic strap, it can be provided that the at least one strip surface of the plastic strap in the region of the microstructure or the microstructure itself has an average roughness Rₐ between 0.1 μm and 2.6 μm. In particular, the at least one strip surface in the region of the microstructure or the microstructure itself can have an average roughness Rₐ between 0.15 μm and 1.6 μm.

Furthermore, it can be advantageous if the at least one strip surface of the plastic strap in the region of the microstructure or the microstructure itself has an averaged roughness depth R_{z} between 1 μm and 15 μm. In particular, the at least one strip surface in the region of the microstructure or the microstructure itself can have an averaged roughness depth R_{z} between 1.5 μm and 12 μm.

A further development can also consist in that the at least one strip surface of the plastic strap in the region of the microstructure or the microstructure itself has an average groove width RSₘ between 50 μm and 400 μm. In particular, the at least one strip surface in the region of the microstructure or the microstructure itself can have an average groove width RSₘ between 100 μm and 300 μm.

As a result of the ranges for profile parameters of the at least one strip surface in the region of the microstructure, as indicated, a plastic strap having a microstructure can be made available, which plastic strap demonstrates very good weldability for forming a strapping, in particular by means of friction welding by machine. Furthermore, the mechanical properties, in particular the tensile strength of the plastic strap is not significantly influenced by a microstructure having the indicated ranges for profile parameters. For this purpose, a restriction of the averaged roughness depth R_{z} to the range indicated, for example, can be advantageous. Also, an average groove width from the range indicated has proven to be advantageous for this purpose. Furthermore, the plastic strap having at least one such profiled strip surface does not demonstrate an increased tendency toward separation in the direction of the longitudinal expanse, in comparison with a smooth, non-profiled strap having the same dimensions and consisting of the same plastic material having the same stretching ratio.

The profile parameters for profiles as indicated, as well as methods for determination of these profile parameters are defined in EN ISO 4287. More recent definitions and area-related or area-capturing measurement methods for profiled surfaces are defined in the standards series EN ISO 25178, wherein the measurement values in turn can be transferred or calculated to produce profile parameters or 2D parameters according to EN ISO 4287. In the case of stretched plastic straps, the profile parameters are supposed to be determined using measurement distances oriented along the main stretching direction or longitudinal expanse, so as to be able to exclude possible measurement errors due to superimposition of longitudinal structures that can result from the stretching procedure.

In a further embodiment of the plastic strap, it can be provided the at least one strip surface of the plastic strap is continuously or entirely provided with the microstructure.

In the case of a plastic strap configured in this manner, it can advantageously be guaranteed that at least one strip surface of the plastic strap is provided with a microstructure in the region of the two longitudinal ends, in each instance, independent of the length of the plastic strap required, in each instance. Furthermore, a continuous microstructure has a positive effect on guidance by machine, as well as on tensioning of the plastic straps during a strapping procedure.

Furthermore, it can be practical that both strip surfaces of the plastic strap are each provided with the or each provided with a microstructure.

In this manner, plastic straps can be produced, which can be processed or guided particularly well in automated manner during the course of strapping or of a strapping procedure by machine. Furthermore, the efficiency of the welding, in particular in the case of friction welding, can be further improved once again with regard to the time and energy expenditure required.

Furthermore, it can be provided that a stretching ratio of the plastic material amounts to between 2 and 20. This with reference to the plastic material before the stretching procedure. Preferably, the stretching ratio amounts to between 3 and 15, particularly between 4 and 12.

Finally, in a further development of the plastic strap, it can be provided that it has a tensile strength between 200 N/mm² and 600 N/mm².

By means of the ranges indicated for tensile strength, a plastic strap that has sufficient tensile strength, in each instance, for a respective purpose of use or respective strapping can be made available. Preferably, the plastic strap can have a tensile strength between 250 N/mm² and 550 N/mm², in particular between 300 N/mm² and 500 N/mm².

For a better understanding of the invention, it will be explained in greater detail using the following figures.

These show, each in a greatly simplified, schematic representation:

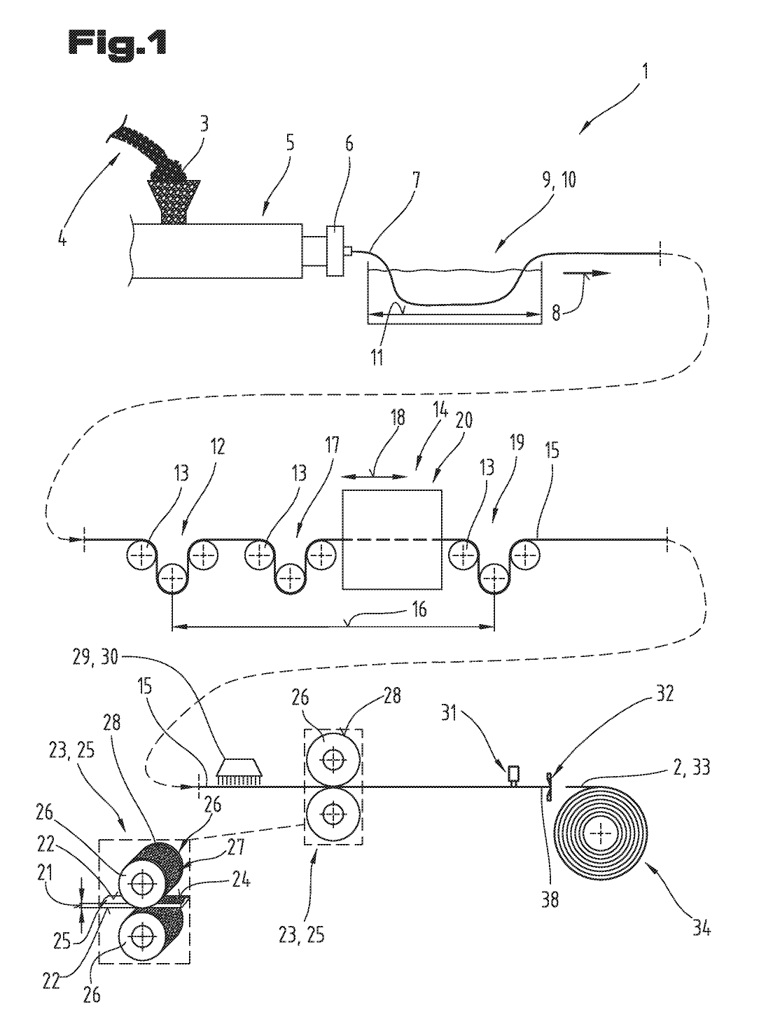

FIG. 1 A schematic representation of a system for production of a plastic strap, which illustrates the method for production;

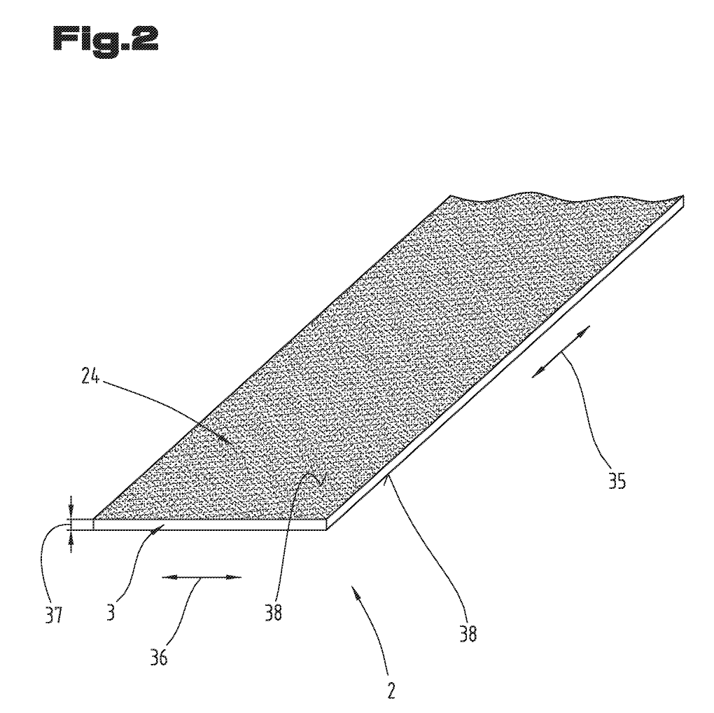

FIG. 2 As a detail, a plastic strap in a top view of a strip surface provided with a microstructure.

As an introduction, it should be stated that in the different embodiments described, the same parts are provided with the same reference symbols or the same component designations, wherein disclosures contained in the description as a whole can be applied analogously to the same parts having the same reference symbols or component designations. Also, the position information selected in the description, such as at the top, at the bottom, at the side, etc., for example, relates only to the figure being directly described and shown, and this position information must be applied analogously to a new position in the case of a change in position.

To avoid repetition, individual embodiments are not listed more explicitly or illustrated graphically in the following description. In this regard, reference is made, in each instance, to the preceding description. In the description as a whole, the term “stretching” is used synonymously with the term “elongation.”

In FIG. 1, an apparatus 1 for production and a method for production of plastic straps 2 are illustrated schematically. At the beginning of the method, a semi-crystalline thermoplastic plastic material 3 is made available.

In this regard, in principle any semi-crystalline thermoplastic plastic material 3 can be made available, which can be thermoplastically rough-formed, stretched, and surface-treated. For example, it can be provided that a plastic material 3 from the group of polyolefins, polyesters, polyamides or from mixtures or blends of these polymer materials is made available. The polymer materials last mentioned are suitable, to a particular degree, for production of straps, since they are very well suited for an extrusion process, for one thing, and furthermore can also be processed, by means of stretching, to produce plastic straps 2 that have a high tensile strength.

Specifically, it can be provided that a polyester, in particular polyethylene terephthalate, is made available as the plastic material 3. Polyesters are particularly well suited for production of straps having excellent mechanical properties, such as high tensile strengths and great rigidity, for example. This in turn has a positive effect on carrying out strapping, in particular on strapping or encircling carried out by machine, and tensioning during a strapping procedure.

As is shown schematically in FIG. 1, the semi-crystalline thermoplastic plastic material can be fed or metered to an extrusion apparatus 5 by way of a feed apparatus or metering apparatus 4. In this regard, fillers and additives, in particular pigments, anti-oxidants and/or other processing aids can also be mixed into the plastic material 3. In the extrusion apparatus 5, for example a screw extruder, the thermoplastic plastic material 3 is then melted, and extruded by way of an extrusion tool 6 disposed on or attached to the extrusion apparatus 5.

For this purpose, it can be provided, for example, that the extrusion tool 6 has one or more die(s), in particular dies having a slot-shaped cross-section, through which slotted die(s) the melted plastic material is pressed or extruded to form a strip-shaped plastic strand 7 or to form multiple strip-shaped plastic strands 7. If multiple strip-shaped or band-shaped plastic strands 7 are extruded, these can run through the subsequent method steps jointly. Alternatively, it can also provided that the extrusion tool 6 comprises a die or slotted die having an expanded cross-section width, in other words what is called a broad-slot die, so that a film-shaped plastic strand 7 having a great width expanse is extruded. After carrying out further method steps, such a film-shaped plastic strand 7 can be separated into band-shaped or strip-shaped strands or strips in a finishing step, along the longitudinal orientation of the plastic strand 7, in each instance, so as to produce straps having suitable dimensions or width expanses. In any case, at least one extruded plastic strand 7 is produced by extrusion by means of the extrusion apparatus 5, the rough shape or rough cross-sectional geometry of which can be established in terms of essential features by way of the die(s) on the extrusion tool 6.

As is furthermore shown in FIG. 1, cooling of the extruded plastic strand 7 can be carried out after extrusion. In this way, in particular, the rough shape or cross-sectional geometry of the extruded plastic strand 7 can be preserved. In principle, passive cooling of the extruded plastic strand 7 by means of ambient air can be carried out for this purpose. If necessary, an air stream can also be used for cooling. Preferably, the extruded plastic strand 7 is passed through a cooling apparatus 9 in the guidance or transport direction 8 for efficient cooling, as shown in FIG. 1. The cooling apparatus 9 shown can be formed by a water bath 10, for example. The cooling apparatus 9 can contain water at a specific temperature, for example, through which the extruded plastic strand 7 is passed. A temperature of the plastic strand 7 after cooling can be influenced or controlled by a specific length 11 of the cooling apparatus 9, for example at a given temperature of the cooling liquid or of the water of the cooling apparatus 9.

A pull-off apparatus 12 can be disposed behind the cooling apparatus 9, for pulling off or guiding the plastic strand 7 in the transport direction 8. As shown in FIG. 1, such a pull-off apparatus 12 can comprise multiple roller elements 13 that rotate at a specific angular velocity, and form a godet trio, for example. In principle, it can also be provided, in this regard, that one or more roller element(s) are structured so that they can be tempered, so that the plastic strand 7 can be heated or cooled for the subsequent further processing, in particular the elongation procedure. For this purpose, the roller element 13 can be tempered by means of tempering liquids, for example, or electrically. Alternatively, other means for tempering a plastic strand 7, such as sprinkler apparatuses, immersion baths or infrared radiators, for example, can also be provided for heating or cooling the plastic strand 7.

The elongation procedure or stretching of the plastic strand 7 to form a stretched strand 15 is carried out by means of an elongation unit 14, as shown in FIG. 1. For this purpose, a further transport or pull-off apparatus 17 having roller elements 13 can be disposed along an elongation segment 16 of the elongation unit 14. All of the roller elements 13 shown in FIG. 1 can rotate at different angular velocities, in each instance, when carrying out the method, to respectively establish a pull-off speed or displacement speed for the plastic strand 7. With regard to the angular velocity during rotation, of course, a respective circumference of the individual roller elements 13 must also be taken into consideration in this regard. For a better illustration, all the roller elements 13 in FIG. 1 have the same circumference. This can hold true or also not hold true in the case of apparatuses 1 for production of plastic straps 2.

In the exemplary embodiment shown in FIG. 1, it can be provided that the roller elements 13 of the pull-off apparatus 17 rotate at a higher angular velocity than the roller elements 13 of the preceding pull-off apparatus 12. In this way, a pull-off speed or transport speed of the further pull-off apparatus 17 is selected to be greater than the pull-off speed for the plastic strand 7 of the preceding pull-off apparatus 12, and the plastic strand 7 is stretched along a main stretching direction 18, i.e. pulled to become longer.

Furthermore, an additional transport or pull-off apparatus 19 can be provided at the end of the elongation unit 14 or of the elongation segment 16. In the case of this additional pull-off apparatus 19, an even greater pull-off speed for the plastic strand 7 than the pull-off speed of the pull-off apparatus 17, which is disposed ahead of it with reference to the transport direction 8, can be provided during operation of the apparatus 1. In this way, the plastic strand 7 can be pulled to become longer or stretched once again between the further pull-off apparatus 17 and the additional pull-off apparatus 19. In total, the plastic strand 7 is elongated monoaxially or at least predominantly monoaxially in the elongation unit 14 or along the elongation segment 16, along the main stretching direction 18, to produce a stretched strand 15.

An elongation ratio for the plastic material 3 can be selected from a range between 2 and 20 in the case of the stretched strand 15. This with reference to the extruded plastic strand 7 before the stretching procedure. During the course of the stretching procedure, a thickness of the plastic strand 7 is therefore also reduced by means of the stretching. Preferably, a stretching ratio for the plastic material 3 is selected from a range between 3 and 15, in particular between 4 and 12. As is evident from FIG. 1, stretching can be carried out predominantly along the main stretching direction 18. However, slight stretching or elongation transverse to the main stretching direction 18 cannot be completely excluded, in this regard, and for this reason a stretched strand 15 can be stretched predominantly monoaxially.

The exemplary embodiment of an elongation unit 14 shown in FIG. 1 only serves as a schematic illustration, and of course such elongation units 14 can also have further elements and apparatus for carrying out or influencing and controlling the stretching procedure. For example, it can be provided, to better carry out an elongation or a stretching procedure, that or multiple heating apparatuses 20 are provided along the elongation segment 16. A plastic strand 7 can be brought to a processing temperature that is advantageous for the stretching procedure, in each instance, by means of such heating apparatuses 20, wherein an advantageous processing temperature depends, among other things, on the plastic material 3 used or made available, in each instance.

After stretching, a stretched strand 15 is present, which has an increased risk for what is called splitting, in other words separation or fraying along the main stretching direction 18, due to the preferential orientation of the macromolecules in the main stretching direction 18 that has now been introduced into the plastic material. The stretched strand 15 has two surfaces 22, which are spaced apart from one another by a thickness 21 of the stretched strand 15.

At least one of these surfaces 22 of the stretched strand 15 is subsequently provided with a microstructure 24 subsequent to stretching, by means of a surface treatment apparatus 23, as is also evident from FIG. 1. In particular, it can be provided that the microstructure 24 cannot be optically resolved with the naked human eye, in other words that the individual structural elements of the microstructure as such are not clearly recognizable as such with the naked human eye.

A surface treatment apparatus 23 can be formed, for example, by means of a laser treatment apparatus, by means of which the microstructure 24 or the micro-pattern can be introduced into the at least one surface 22 of the stretched strand 15. This can take place, for example, by means of partial ablation, i.e. in certain sections, in the micrometer range, or also by melting, in certain sections, of the at least one surface 22, in the micrometer range. Alternatively, however, a surface treatment apparatus 23 in the manner of a sand-blasting apparatus, for processing of the at least one surface 22 of the stretched strand 15 with solid particles, is also conceivable for providing the at least one surface 22 of the stretched strand 15 with a microstructure 24. In this regard, the solid particles used can have a particle size in the single-digit and/or two-digit micrometer range for application or introduction of the microstructure 24. Likewise, chemical methods for providing the at least one surface 22 with a microstructure 24 are conceivable, for example etching surface(s) 22 of the stretched plastic strand 15.

Preferably, a surface treatment apparatus 23 structured as an embossing apparatus 25 is used for providing the at least one surface 22 with the microstructure 24. Such an embossing apparatus 25 can comprise at least one embossing roll 26, which embossing roll 26 is brought into contact with the stretched strand 15, as shown in FIG. 1. In this manner, a microstructured surface profile 27 can be transferred from an embossing surface 28 of the embossing roll 26 onto the at least one surface 22 of the stretched strand 15. In this regard, the microstructure 24 is introduced into the at least one surface 22 of the stretched strand 15 as a negative structure of the microstructured surface profile 27 of the embossing surface 28. It is understood that slight deviations of the microstructure 24 essentially formed as a negative of the surface profile 27 from the actual surface profile 27 of the embossing surface 28 of the embossing roll 26 are possible. It is advantageous if only a slight press-down pressure of the embossing roll 26 onto the at least one surface 22 of the stretched strand 15 is required for providing it with the microstructure 24.

The microstructured embossing surface 28 of the embossing roll 26, i.e. the surface profile 27 can be produced, for example, by means of a laser ablation apparatus. If necessary, other physical methods, or also mechanical methods, for example grinding processes and the like, or also chemical methods such as chemical removal of layers close to the surface, are also possible for production of the surface profile 27 on the embossing surface 28 of an embossing roll 26.

Fundamentally, it can be provided that an embossing roll 26 having an embossing surface 28 with a structurally well-defined or orderly surface profile 27, in other words with a surface profile 27 having recurring structural elements, is used. Laser ablation apparatuses having a corresponding track controller of one or more laser beam(s), suitable for production of the structurally ordered surface profile 27, for example, are suitable for production of such surface profiles 27.

However, it can also be practical if the at least one surface 22 of the stretched strand 15 is provided with the microstructure 24 by means of at least one embossing roll 26 having a surface profile 27 with a random structure. Measures for ordered structuring with recurring or repeating structure units can be eliminated for production of such surface profiles 27. For example, a random structure can be produced by means of a laser apparatus, in particular a laser ablation apparatus, the laser beam(s) of which are guided over the surface of the corresponding embossing roll 26 in a restrictedly random-generated track pattern. If necessary, other physical methods or mechanical methods, for example bombardment with particles in the sense of sand-blasting or grinding, or also chemical methods such as chemical removal of layers close to the surface, for production of a random microstructure or for production of the embossing surface 28 of an embossing roll 26, the surface having a randomly structured surface profile 27, are possible.

In FIG. 1, the at least one surface 22 of the stretched strand 15 after the surface treatment, as well as the embossing surface 28 of the embossing roll 26 were shown with a graphic filling to illustrate the microstructure 24 and the microstructured surface profile 27 of the embossing roll 26. In this regard, the filling selected was shown merely as an illustration, and this filling should not be interpreted as an image of an actual microstructure 24 or of an actual surface profile 27, for example. Embodiments of actual microstructures 24 or surface profiles 27 can be found in the description text.

Fundamentally, it can be provided that the at least one surface 22 of the stretched strand 15 is provided with the microstructure 24 by means of at least one embossing roll 26, having a surface profile 27 or an embossing surface 28 having an average roughness Rₐ between 2 μm and 15 μm. The average roughness Rₐ is frequently also referred to as an arithmetical medium roughness value. Preferably, an embossing roll 26 is used that has a surface profile 27 or embossing surface 28 with an average roughness Rₐ between 4 μm and 12 μm.

Furthermore, it can be advantageous if the at least one surface 22 of the stretched strand 15 is provided with the microstructure 24 by means of at least one embossing roll 26 having a surface profile 27 or an embossing surface 28 with an averaged roughness depth R_{z} between 10 μm and 100 μm. Preferably, an embossing roll 26 is used that has a surface profile 27 or embossing surface 28 with an averaged roughness depth R_{z} between 20 μm and 80 μm.

Furthermore, it can be practical if the at least one surface 22 of the stretched strand 15 is provided with the microstructure 24 by means of at least one embossing roll 26 having a surface profile 27 or an embossing surface 28 with an average groove width RSₘ between 50 μm and 400 μm. Preferably, an embossing roll 26 is used that has a surface profile 27 or embossing surface 28 with an average groove width RSₘ between 100 μm and 300 μm.

By means of the indicated ranges for profile parameters at least for sections of the embossing surface 28 of the embossing roll 26, stretched strands 15 can be provided with a correspondingly structured embossing structure or microstructure 24. During the course of the embossing procedure, the micro-surface profile 27 of the embossing surface 28, having the indicated ranges of the profile parameters, is transferred accordingly to the at least one surface 22 of the stretched strip 15 as a negative structure, at least to a great extent, as illustrated in FIG. 1. In this regard, of course, a resulting roughness and a resulting averaged roughness depth depend on a respective penetration depth of the embossing surface 28 of the embossing roll 26 into the stretched strip 15 during the embossing procedure, i.e. they can be varied by means of a respective penetration depth.

The profile parameters for profiles as indicated, as well as methods for determination of these profile parameters, are defined in EN ISO 4287. More recent definitions and area-related or area-capturing measurement methods for profiled surfaces are defined in the standards series EN ISO 25178, wherein the measurement values can in turn be transferred or converted to profile parameters or 2D parameters according to EN ISO 4287.

In principle, it can be provided that the embossing surface 28 of the embossing roll 26 has a microstructured surface profile 27 in certain sections, and thereby in the method, only partial sections of the at least one surface of the stretched strand 15 are provided with the microstructure 24.

Preferably, the at least one surface 22 of the stretched strand 15 is provided with the microstructure 24 continuously, as is also shown in FIG. 1. In this way, it can be guaranteed, among other things, that at least one strip surface of a plastic strap 2 is provided, in each instance, with the or with a microstructure 24, in each instance, in the region of the two longitudinal ends. In this way, plastic straps 2 can be produced, in which a microstructure 24 is made available, in each instance, on at least one strip surface in the region, for improved welding, independent of a respective longitudinal expanse required for strapping or encircling of goods.

In cases in which only one surface 22 of the stretched strand 15 is provided with the microstructure 24, the stretched strand 15 can be passed through between the embossing roll 26 and a further guide roll having a smooth or non-profiled surface, for example with direct contact, in each instance. Alternatively, a guide track having a smooth surface can also be provided opposite the embossing roll, for example.

However, it can also be advantageous if both surfaces 22 of the stretched strand 15 are provided, in each instance, with the or with a microstructure 24, in each instance.

As shown in FIG. 1, the stretched strand 15 can is passed through between at least two embossing rolls 26 that lie opposite one another and rotate in opposite directions for this purpose, and both surfaces 22 of the stretched strand 15 can be provided with the microstructure 24, in each instance, by means of the two embossing rolls 26.

In this manner, plastic straps 2 can be produced that can be guided and welded particularly well in automated manner during the course of strapping or of a strapping procedure by machine. Alternatively to processing of a stretched strand 15 on both sides, with an embossing roll 26, in each instance, of course the two surfaces 22 of a stretched strand 15 can also be treated with other surface treatment apparatuses 23, for example by bombardment with particles, etc. Preferably, an embossing apparatus 25 with embossing rolls 26 is used for providing the surfaces 22 of a stretched band 15 with the microstructure 24.

In this regard, it can also be provided that at least one of the embossing rolls 26 shown in the exemplary embodiment in FIG. 1 is structured so that it can be tempered. For this purpose, the at least one embossing roll 26 can have channels for passing a tempered liquid medium through them. Of course, both of the embossing rolls 26 shown in FIG. 1 can also be structured so that they can be tempered. Also, electrical heating of at least one of the embossing rolls 26 shown is possible, for example. In this way, the stretched strand 15 or the stretched strands 15 can be tempered by means of at least one embossing roll 26.

Alternatively and/or in addition, a stretched or elongated strand 15 can also be tempered by means of a tempering apparatus 29 that precedes the at least one embossing roll 26. In principle, any apparatus suitable for heating or cooling a stretched strand 15 can be used as a preceding tempering apparatus 29. For example, the use of a further water bath is conceivable. In this regard, such a water bath can either be provided for cooling a stretched strand 15, or such a water bath can be heated, so as to heat a stretched strand 15. Alternatively or in addition, heating of a stretched strand 15 by means of infrared radiation is also conceivable. In FIG. 1, a sprinkling apparatus 30 is shown as an example of a preceding tempering apparatus 29, by means of which a stretched strand 15 can be sprinkled with a liquid having a preset or adjustable temperature.

The procedure for providing the at least one surface 22 with the microstructure 24 can be significantly influenced by tempering of the stretched strand 15 or of the stretched strands 15, since the temperature during micro-embossing influences the plastic formability of a stretched strand 15. Furthermore, the risk of damage to a plastic strap 2 during production or during use can be further prevented by means of suitable tempering for the surface treatment. A respective temperature of a stretched strand 15, suitable for the surface treatment for providing at least one surface 22 with the microstructure 24, is also dependent on the plastic material 3 made available, in each instance.

Fundamentally, it can be provided that the at least one surface 22 of the stretched strand 15 is provided with the microstructure 24 at a temperature of the stretched strand 15 between 60° C. and 120° C. This temperature range for a stretched strand 15 has proven to be particularly practical for providing at least one surface 22 with the microstructure 24.

At the end of the method, further process steps for final production of the stretched strand 15 or of the stretched strands 15 can also be provided for production of plastic straps 2. For example, a division apparatus 31 can be provided so as to divide a stretched and surface-treated strand 15 into multiple partial strands. This is particularly practical so as to obtain plastic straps 2 from a film-shaped strand 15 having a relatively great width expanse transverse to the transport direction 8. In this regard, it can be provided that such a stretched strand 15 is divided when viewed over its width. The division apparatus 31 can have cutting blades or cutting rolls, for example.

Furthermore, a splitting-up apparatus 32 can also be provided for final production. Such a splitting-up apparatus 32 can be configured for cutting a strand 15 of multiple strands 15, if applicable obtained by division with the division apparatus 31, into pieces 33 suitable for storage or for transport. For storage or for transport, these pieces 33 can be wound onto spools 34, for example, as illustrated in FIG. 1. Such spools 34 can be used, in particular, for portioning of large amounts, wherein plastic straps 2 for final use or sale can be cut off from such a spool 34 in suitable lengths, in each instance. Alternatively, of course, direct splitting-up into lengths of plastic straps 2 ready for use is also possible.

In FIG. 2, a detail of a plastic strap 2 ready for use is shown in perspective. The plastic strap 2 can be produced, in particular, by means of the method described.

The plastic strap 2 shown has a longitudinal expanse 35 and, normal to it, a width expanse 36 and a strip thickness 37. The longitudinal expanse 35 and width expanse 36 form two strip surfaces 38 that are spaced apart from one another by the strip thickness 37. The plastic strap 2 comprises a semi-crystalline thermoplastic plastic material 3, which plastic material 3 is stretched monoaxially or predominantly monoaxially in the direction of the longitudinal expanse 35. The plastic material 3 can specifically be a polyester; in particular, the plastic material can be formed by polyethylene terephthalate.

It is essential that one of the strip surfaces 38 of the plastic strap 2 is provided with a microstructure 24, in particular with a microstructure 24 that cannot be optically resolved by the human eye, as illustrated in FIG. 2. Such a plastic strap 2 is excellently suited for partly automated or fully automated strapping procedures performed by machine, due to the microstructure 24. In the case of a plastic strap 2 in which only one strip surface 38 is provided with a microstructure 24, the strip surface 38 having the microstructure 24 can be welded to the opposite, non-structured or smooth strip surface 38, during welding of the two longitudinal ends in each instance.

In FIG. 2, once again for illustration of the microstructure 24, the at least one strip surface 22 of the plastic strap 2 was shown with a graphic filling. In this regard, the selected filling is shown only for the sake of illustration, and this filling should not be interpreted as an image of an actual microstructure 24, for example. Embodiments of actual microstructures 24 can be found in the description text.

Preferably, both strip surfaces 38 of the plastic strap 2 are provided, in each instance, with the or with a microstructure 24, in each instance. In particular, in this way, the efficiency of a weld, in particular in the case of friction welding, during the course of a strapping procedure, can be further improved once again with regard to the expenditure of time and energy, since in this case, two strip surfaces 38 of a plastic strap 2, each having a microstructure 24, are welded to one another.

In principle, it is furthermore possible that only partial sections of the at least one surface 38 of the plastic 2 strap are provided with the microstructure 24 or with a microstructure 24, in each instance. Preferably, the at least one strip surface 38 is continuously provided with the microstructure 24, as is also illustrated in FIG. 2. This brings with it the advantage, among other things, that independent of the length of the plastic strap 2 required for a specific strapping for encircling, in each instance, at least one strip surface 38, in each instance, has a microstructure 24 in the region of the longitudinal ends to be welded together.

A stretching ratio of the plastic material 3 of the plastic strap 2 can amount to between 2 and 20. This with reference to the plastic material 3 before the stretching procedure. Preferably, the stretching ratio amounts to between 3 and 15, particularly between 4 and 12.

Subsequently, it can be provided that the plastic strap 2 has a tensile strength between 200 N/mm² and 600 N/mm². By means of the ranges indicated for tensile strength, a plastic strap that has sufficient tensile strength, in each instance, for a respective purpose of use or respective strapping can be made available. Preferably, the plastic strap can have a tensile strength between 250 N/mm² and 550 N/mm², in particular between 300 N/mm² and 500 N/mm².

A strip thickness 37 of the plastic strap 2 can amount to between 0.2 mm and 1.6 mm, for example. Preferably, a strip thickness 37 amounts to between 0.25 mm and 1.4 mm, in particular between 0.3 mm and 1.3 mm. It is obvious to a person skilled in the art that the strip thickness 37 of the plastic strap 2 can vary at least slightly, for example in the single-digit or two-digit micrometer range, in particular due to the microstructure 24, in certain sections or certain regions along the plastic strap 2.

The microstructure 24 can comprise individual structural elements such as elevations and depressions, the expanse or dimension of which lies in the single-digit to two-digit micrometer range. In particular, a microstructure 24 on the at least one strip surface 38 of the plastic strap 2 cannot be clearly optically resolved by the naked human eye, for example from a distance of 1 meter. This means that the microstructure 24 cannot be recognized as a structure by the human eye from an observation distance of 1 meter. This does not mean that the at least one microstructured strip surface 38 of a plastic strap 2 according to the invention could not be differentiated from a surface of a smooth strap without a microstructure 24. As a result of the microstructure 24, the at least one strip surface 38 can appear, in particular, to be more matte, in other words frosted in comparison with a smooth surface of the same plastic material without a microstructure 24.

In particular, the microstructure 24 can be formed by an embossed microstructure, in other words the at least one strip surface 38 was provided with the microstructure 24 by means of an embossing apparatus 25 comprising at least one embossing roll 26.

The microstructure 24 can fundamentally be formed by a structurally well-defined or ordered structure in the micrometer range. This means that the microstructure 24 can have recurring structural elements. In particular, however, it can also be provided that the microstructure 24 is formed by a random structure. Such a microstructure 24, formed by a random pattern, can be introduced into the at least one strip surface 38 of the plastic strap 2 or applied to the at least one strip surface 38 with relatively little effort.

In the case of the plastic strap 2 shown in FIG. 2, it can be provided that the at least one strip surface 38 has an average roughness Rₐ between 0.1 μm and 2.6 μm in the region of the microstructure 24 or brought about by the microstructure 24. In particular, the at least one strip surface 38 can have an average roughness Rₐ between 0.15 μm and 1.6 μm in the region of the microstructure 24 or brought about by the microstructure 24.

Furthermore, it can be advantageous if the at least one strip surface 38 of the plastic strap 2 has an averaged roughness depth R_{z} between 1 μm and 15 μm in the region of the microstructure 24 or brought about by the microstructure 24. In particular, the at least one strip surface 38 can have an averaged roughness depth R_{z} between 1.5 μm and 12 μm in the region of the microstructure 24 or brought about by the microstructure 24.

Finally, it can be practical if the at least one strip surface 38 of the plastic strap 2 has an average groove width RSₘ between 50 μm and 400 μm in the region of the microstructure 24 or brought about by the microstructure 24. In particular, the at least one strip surface 38 can have an average groove width RSₘ between 100 μm and 300 μm in the region of the microstructure 24 or brought about by the microstructure 24.

By means of the indicated ranges for profile parameters, a plastic strap 2 can be made available, in which excellent mechanical properties, in particular high tensile strengths are implemented simultaneously with good processing properties, in particular with regard to guidance and welding by machine.

The profile parameters for profiles as indicated, as well as methods for determination of these profile parameters, are defined in EN ISO 4287. More recent definitions and area-related or area-capturing measurement methods for profiled surfaces are defined in the standards series EN ISO 25178, wherein the measurement values can in turn be transferred or converted to profile parameters or 2D parameters according to EN ISO 4287. In the case of stretched plastic straps 2, the profile parameters are supposed to be determined using measurement segments oriented along the main stretching direction 18 or the longitudinal expanse 35, so as to be able to exclude possible measurement errors caused by superimposition of longitudinal structures, which can occur on the basis of the stretching procedure.

The ranges indicated for values of the roughness and groove width are average values determined according to EN ISO 4287 from a plurality of measurement segments. In this regard, a microstructure 24 can have individual structural elements, such as depressions and elevations, for example, the dimensions of which deviate greatly from one another, in each instance. Thus, a microstructure 24 can have individual structural elements, the individual dimensions of which lie in the single-digit or two-digit micrometer range, in each instance, or, in borderline cases, also in the low three-digit micrometer range. The dimensions of individual structural elements of the microstructure 24 can therefore certainly vary by more than a power of ten or even slightly above that. This in particular if the microstructure is formed by a random structure.

The exemplary embodiments show possible embodiment variants, wherein it should be noted at this point that the invention is not restricted to the embodiment variants that are specifically represented, but rather, instead, various combinations of the individual embodiment variants with one another are possible, and this variation possibility lies within the ability of a person skilled in the art and working in this technical field, on the basis of the teaching concerning technical action provided by the present invention.

The scope of protection is determined by the claims. However, the description and the drawings must be used to interpret the claims. Individual characteristics or combinations of characteristics from the different exemplary embodiments shown and described can represent independent inventive solutions on their own. The task on which the independent inventive solutions are based can be derived from the description.

All information regarding value ranges in the present description should be understood to mean that these include any and all partial ranges of them; for example, the information 1 to 10 should be understood to mean that all partial ranges, proceeding from the lower limit 1 and also including the upper limit 10 are also included; i.e. all partial ranges start with a lower limit of 1 or more and end at an upper limit of 10 or less, for example 1 to 1.7, or 3.2 to 8.1, or 5.5 to 10.

For the sake of good order, it should be pointed out, in conclusion, that for a better understanding of the structure, some elements have been shown not to scale and/or larger and/or smaller.

### REFERENCE SYMBOL LISTING

1 apparatus

2 plastic strap

3 plastic material

4 metering apparatus

5 extrusion apparatus

6 extrusion tool

7 plastic strand

8 transport direction

9 cooling apparatus

10 water bath

11 length

12 pull-off apparatus

13 roller element

14 elongation unit

15 strand

16 elongation segment

17 pull-off apparatus

18 main stretching direction

19 pull-off apparatus

20 heating apparatus

21 thickness

22 surface

23 surface treatment apparatus

24 microstructure

25 embossing apparatus

26 embossing roll

27 surface profile

28 embossing surface

29 tempering apparatus

30 sprinkling apparatus

31 division apparatus

32 splitting-up apparatus

33 piece

34 spool

35 longitudinal expanse

36 width expanse

37 strip thickness

38 strip surface

1-21. (canceled)

22. A method for production of plastic straps (2), comprising:
making available a semi-crystalline, thermoplastic plastic material (3), melting the plastic material (3), and extrusion of the melted plastic material (3) to form at least one plastic strand (7), by means of an extrusion apparatus (5),
cooling of the extruded plastic strand (7),
monoaxial or predominantly monoaxial stretching of the cooled plastic strand (7) to form a stretched strand (15), by means of at least one elongation unit (14), which stretched strand (15) has two surfaces (22), which are spaced apart from one another by a thickness (21) of the stretched strand (15),
wherein at least one surface (22) of the stretched strand (15) is provided with a microstructure (24), by means of a surface treatment apparatus (23), in particular with a microstructure (24) that cannot be optically resolved by the naked human eye, and
wherein an embossing apparatus (25) comprising at least one embossing roll (26) is used as the surface treatment apparatus (23),
wherein the at least one surface (22) of the stretched strand (15) is provided with the microstructure (24) by means of at least one embossing roll (26), having a surface profile (27) with an average roughness Rₐ between 2 μm and 15 μm.

23. The method according to claim 22, wherein the at least one surface (22) of the stretched strand (15) is provided with the microstructure (24) by means of at least one embossing roll (26), having a surface profile (27) with an averaged roughness depth R_{z} between 10 μm and 100 μm.

24. The method according to claim 22, wherein the at least one surface (22) of the stretched strand (15) is provided with the microstructure (24) by means of at least one embossing roll (26), having a surface profile (27) with an average groove width RSₘ between 50 μm and 400 μm.

25. The method according to claim 22, wherein the at least one surface (22) of the stretched strand (15) is continuously provided with the microstructure (24).

26. The method according to claim 22, wherein both surfaces (22) of the stretched strand (15) are each provided with a microstructure (24).

27. The method according to claim 26, wherein the stretched strand (15) is passed through between at least two embossing rolls (26) that lie opposite one another and rotate in opposite directions, each having microstructured embossing surfaces (28), and wherein both surfaces (22) of the stretched strand (15) are each provided with a microstructure (24) by means of the two embossing rolls (26).

28. The method according to claim 22, wherein the at least one surface (22) of the stretched strand (15) is provided with a microstructure (24) at a temperature of the stretched strand (15) between 60° C. and 120° C.

29. The method according to claim 28, wherein the stretched strand (15) is tempered by means of at least one embossing roll (26) and/or by means of a tempering apparatus (29) that precedes the at least one embossing roll (26).

30. A plastic strap (2) having a longitudinal expanse (35) and, normal to it, a width expanse (36) and a strip thickness (37), which longitudinal expanse (35) and width expanse (36) form two strip surfaces (38) that are spaced apart from one another by the strip thickness (37),
wherein the plastic strap (2) comprises a semi-crystalline thermoplastic plastic material (3), which plastic material (3) is stretched monoaxially or predominantly monoaxially in the direction of the longitudinal expanse (35), and
wherein at least one of the strip surfaces (38) of the plastic strap (2) is provided with a microstructure (24), in particular with a microstructure (24) that cannot be resolved optically by the human eye, and
wherein the microstructure (24) is formed by an embossed microstructure,
wherein the at least one strip surface (38) of the plastic strap (2) has an average roughness Rₐ between 0.1 μm and 2.6 μm in the region of the microstructure (24).

31. The plastic strap according to claim 30, wherein the microstructure (24) is formed by a random structure.

32. The plastic strap according to claim 30, wherein the at least one strip surface (38) of the plastic strap (2) has an averaged roughness depth R_{z} between 1 μm and 15 μm in the region of the microstructure (24).

33. The plastic strap according to claim 30, wherein the at least one strip surface (38) of the plastic strap (2) has an average groove width RSₘ between 50 μm and 400 μm in the region of the microstructure (24).

34. The plastic strap according to claim 30, wherein the at least one strip surface (38) of the plastic strap (2) is continuously provided with the microstructure (24).

35. The plastic strap according to claim 30, wherein both strip surfaces (38) of the plastic strap (2) are each provided with a microstructure (24).

36. The plastic strap according to claim 30, wherein a stretching ratio of the plastic material (3) amounts to between 2 and 20.

37. The plastic strap according to claim 30, wherein it has a tensile strength between 200 N/mm² and 600 N/mm².
